(19) United States
(12) Patent Application Publication
(10) Pub. No.: US 2025/0005925 A1
(43) Pub. Date: Jan. 2, 2025

(54) MULTIMODAL DEEPFAKE DETECTION VIA LIP-AUDIO CROSS-ATTENTION AND FACIAL SELF-ATTENTION

(71) Applicant: Purdue Research Foundation, West Lafayette, IN (US)

(72) Inventors: Aniket Bera, West Lafayette, IN (US); Aaditya Kharel, West Lafayette, IN (US); Manas Aniruddha Paranjape, Plano, TX (US)

(73) Assignee: Purdue Research Foundation, West Lafayette, IN (US)

(21) Appl. No.: 18/644,697

(22) Filed: Apr. 24, 2024

Related U.S. Application Data
(60) Provisional application No. 63/510,416, filed on Jun. 27, 2023.

(51) Int. Cl. G06V 20/40; G06V 10/82; G06V 10/98; G06V 40/16

(52) U.S. Cl. CPC G06V 20/41; G06V 10/82; G06V 10/993; G06V 40/161

(57) ABSTRACT

A novel multi-modal audio video framework is disclosed. The framework advantageously leverages both audio and video information to accurately detect whether the video has been manipulated, e.g., detect whether the video is a so-called ‘deepfake.’ In a video-only pipeline, the framework adopts a vision encoder having a feature extractor and a Transformer encoder that leverages self-attention mechanisms to detect artifacts in a facial region of the video. Additionally, in a separate audio-video pipeline, the framework adopts an audio+lip encoder having a Transformer encoder that leverages cross-attention mechanisms to identify discrepancies between lip movements of the person and words spoken by the person in the video. These two modalities are used jointly to make an inference as to whether the video has been manipulated.

This application claims the benefit of priority of U.S. provisional application Ser. No. 63/510,416, filed on Jun. 27, 2023 the disclosure of which is herein incorporated by reference in its entirety.

### FIELD

The device and method disclosed in this document relates to machine learning and, more particularly, to multimodal deepfake detection via lip-audio cross-attention and facial self-attention.

### BACKGROUND

Unless otherwise indicated herein, the materials described in this section are not admitted to be the prior art by inclusion in this section.

The term ‘deepfake’ refers to the application of deep learning techniques to generate manipulated digital media, such as video or audio, often with malicious intent for purposes like fraud, defamation, and the dissemination of disinformation or propaganda. The proliferation of deepfakes poses a significant threat to the authenticity and credibility of digital media, causing adverse effects on businesses, governments, and political leaders as it becomes increasingly difficult for humans to discern whether a piece of audio or video has been manipulated.

Although multimedia forgery is not a novel phenomenon, advancements in deep learning and the development of generative adversarial networks (GAN) have revolutionized the fields of computer vision and deepfake generation. State-of-the-art techniques, such as FaceSwap, FakeApp, FaceShifter, Face2Face, DeepFaceLab, and Neural Textures, have been employed to create deepfakes by swapping faces in original videos with target images. The widespread availability of deepfake generation methods necessitates the development of sophisticated deep learning techniques to combat the issue.

Several convolutional neural network (CNN) architectures have been proposed for deepfake detection. Recurrent neural networks have also been utilized to capture time dependencies in deepfake detection tasks. More recently, transformer-based architectures with multi-head attention mechanisms have demonstrated promising results compared to CNN-based methods. However, most deepfake detection techniques focus on either video or audio modalities. This is primarily due to the scarcity of datasets featuring both audio and video deepfakes. Datasets like UADFV, FaceForensics++, DFD, CelebDF, and Deeper Forensics 1.0 contain video-only deepfakes. However, ignoring the audio modality can be problematic, as audio provides crucial information for multimodal deepfake detection tasks. In contrast, the Deepfake Detection Challenge (DFDC), DF-TIMIT, and FakeAVCeleb datasets feature deepfakes in both audio and video modalities.

Accordingly, given the rise in accessibility of deepfake generation, what is needed are deepfake detection methods that consider both audio and video modalities in real-time.

### SUMMARY

A method is disclosed for detecting whether a video has been manipulated. The method comprises receiving, with a processor, a video including a plurality of frames and audio of a person speaking. The method further comprises determining, with the processor, a first embedding based on the plurality of frames of the video using a first neural network, the first neural network incorporating a self-attention mechanism and being configured to detect artifacts in a facial region of the plurality of frames of the video. The method further comprises determining, with the processor, a second embedding based on the audio of the video and the plurality of frames of the video using a second neural network, the second neural network incorporating a cross-attention mechanism and being configured to identify discrepancies between (i) lip movements of the person in the plurality of frames of the video and (ii) words spoken in the audio of the video. The method further comprises determining, with the processor, whether the video has been manipulated based on both the first embedding and the second embedding.

A non-transitory computer-readable medium that stores program instructions for detecting whether a video has been manipulated is disclosed. The program instructions are configured to, when executed by a processor, cause the processor to receive a video including a plurality of frames and audio of a person speaking. The program instructions are further configured to, when executed by a processor, cause the processor to determine a first embedding based on the plurality of frames of the video using a first neural network, the first neural network incorporating a self-attention mechanism and being configured to detect artifacts in a facial region of the plurality of frames of the video. The program instructions are further configured to, when executed by a processor, cause the processor to determine a second embedding based on the audio of the video and the plurality of frames of the video using a second neural network, the second neural network incorporating a cross-attention mechanism and being configured to identify discrepancies between (i) lip movements of the person in the plurality of frames of the video and (ii) words spoken in the audio of the video. The program instructions are further configured to, when executed by a processor, cause the processor to determine whether the video has been manipulated based on both the first embedding and the second embedding.

### BRIEF DESCRIPTION OF THE DRAWINGS

The foregoing aspects and other features of the system and method are explained in the following description, taken in connection with the accompanying drawings.

FIG. 1 summarizes a multi-modal deepfake detection model configured to detect whether a video is a deepfake video or has otherwise been manipulated.

FIG. 2 shows an exemplary embodiment of a computing device that can be used to implement the deepfake detection model.

FIG. 3 shows a flow diagram for a method for detecting whether a video is a deepfake video or has otherwise been manipulated.

FIG. 4 shows a detailed network architecture of the deepfake detection model.

FIG. 5 shows a cuboid embedding for spatio-temporal 3-D attention.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art which this disclosure pertains.

### Overview

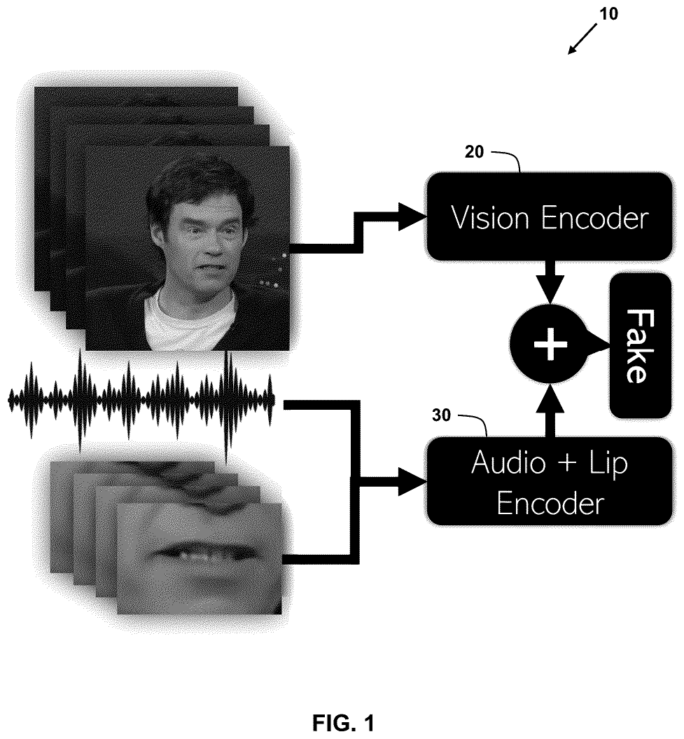

FIG. 1 summarizes a multi-modal deepfake detection model 10 configured to detect whether a video is a deepfake video or has otherwise been manipulated. The deepfake detection model 10 advantageously leverages both audio and video information for deepfake detection. The deepfake detection model 10 has been evaluated through rigorous ablation studies and the multi-modal approach leveraged by the deepfake detection model 10 has been demonstrated to outperform state-of-the-art methods in deepfake detection, even when compared to unimodal approaches with significantly more trainable parameters.

As will be discussed in greater detail below, the deepfake detection model 10 advantageously incorporates a multi-modal pipeline that employs, on one hand, a vision encoder 20 configured to process the video to detect deepfake artifacts in facial regions and, on the other hand, an audio+lip encoder 30 configured to process both audio and video to identify discrepancies between lip movements and audio. The vision encoder 20 of the deepfake detection model 10 employs a feature extractor (e.g., VGG-16) and Transformer encoder that leverages self-attention mechanisms to detect deepfake artifacts in facial regions. In contrast, the audio+lip encoder 30 employs a Transformer encoder that leverages cross-attention mechanisms to identify discrepancies between lip movements and audio. The two modalities are used jointly to make an inference as to whether a video is a deepfake video or has otherwise been manipulated.

### Exemplary Hardware Embodiment

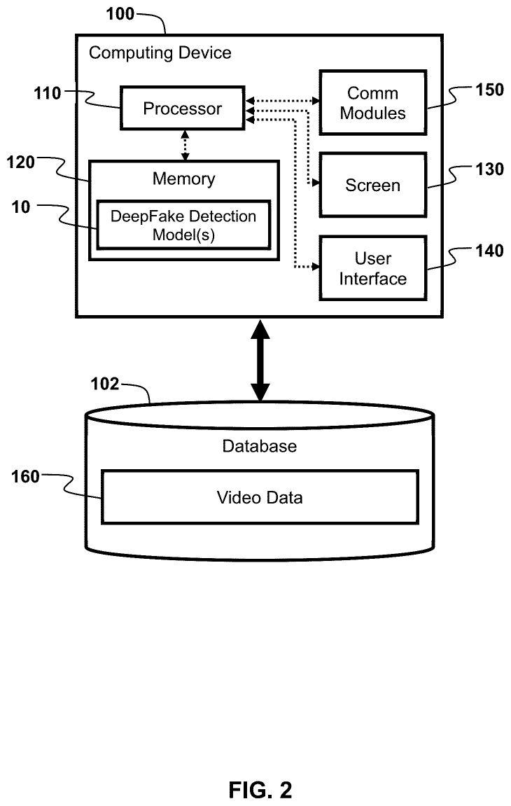

FIG. 2 shows an exemplary embodiment of a computing device 100 that can be used to implement the deepfake detection model 10. Likewise, the computing device 100 might also be used to train the deepfake detection model 10. The computing device 100 comprises a processor 110, a memory 120, a display screen 130, a user interface 140, and at least one network communications module 150. It will be appreciated that the illustrated embodiment of the computing device 100 is only one exemplary embodiment and is merely representative of any of various manners or configurations of a server, a desktop computer, a laptop computer, mobile phone, tablet computer, or any other computing devices that are operative in the manner set forth herein. In at some embodiments, the computing device 100 is in communication with a database 102, which may be hosted by another device or which is stored in the memory 120 of the computing device 100 itself.

The processor 110 is configured to execute instructions to operate the computing device 100 to enable the features, functionality, characteristics and/or the like as described herein. To this end, the processor 110 is operably connected to the memory 120, the display screen 130, and the network communications module 150. The processor 110 generally comprises one or more processors which may operate in parallel or otherwise in concert with one another. It will be recognized by those of ordinary skill in the art that a “processor” includes any hardware system, hardware mechanism or hardware component that processes data, signals, or other information. Accordingly, the processor 110 may include a system with a central processing unit, graphics processing units, multiple processing units, dedicated circuitry for achieving functionality, programmable logic, or other processing systems.

The memory 120 is configured to store data and program instructions that, when executed by the processor 110, enable the computing device 100 to perform various operations described herein. The memory 120 may be any type of device capable of storing information accessible by the processor 110, such as a memory card, ROM, RAM, hard drives, discs, flash memory, or any of various other computer-readable media serving as data storage devices, as will be recognized by those of ordinary skill in the art.

The display screen 130 may comprise any of various known types of displays, such as LCD or OLED screens, configured to display graphical user interfaces. The user interface 140 may include a variety of interfaces for operating the computing device 100, such as buttons, switches, a keyboard or other keypad, speakers, and a microphone. Alternatively, or in addition, the display screen 130 may comprise a touch screen configured to receive touch inputs from a user.

The network communications module 150 may comprise one or more transceivers, modems, processors, memories, oscillators, antennas, or other hardware conventionally included in a communications module to enable communications with various other devices. Particularly, the network communications module 150 generally includes an ethernet adaptor or a Wi-Fi® module configured to enable communication with a wired or wireless network and/or router (not shown) configured to enable communication with various other devices. Additionally, the network communications module 150 may include a Bluetooth® module (not shown), as well as one or more cellular modems configured to communicate with wireless telephony networks.

In at least some embodiments, the memory 120 stores program instructions of the deepfake detection model 10 that, once trained, are configured to process videos to detect whether the videos are deepfake videos. In at least some embodiments, the database 102 stores a plurality of video data 160, which may include a plurality of training video data that are labeled with ground truth labels (i.e., labels indicating whether a respective training video is or isn't a deepfake video).

### Methods and Models for DeepFake Detection

A variety of operations and processes are described below for operating the computing device 100 to operate the deepfake detection model 10 to determine whether a video is a deepfake video or has otherwise been manipulated. In these descriptions, statements that a method, processor, and/or system is performing some task or function refers to a controller or processor (e.g., the processor 110 of the computing device 100) executing programmed instructions stored in non-transitory computer readable storage media (e.g., the memory 120 of the computing device 100) operatively connected to the controller or processor to manipulate data or to operate one or more components in the computing device 100 or of the database 102 to perform the task or function. Additionally, the steps of the methods may be performed in any feasible chronological order, regardless of the order shown in the figures or the order in which the steps are described.

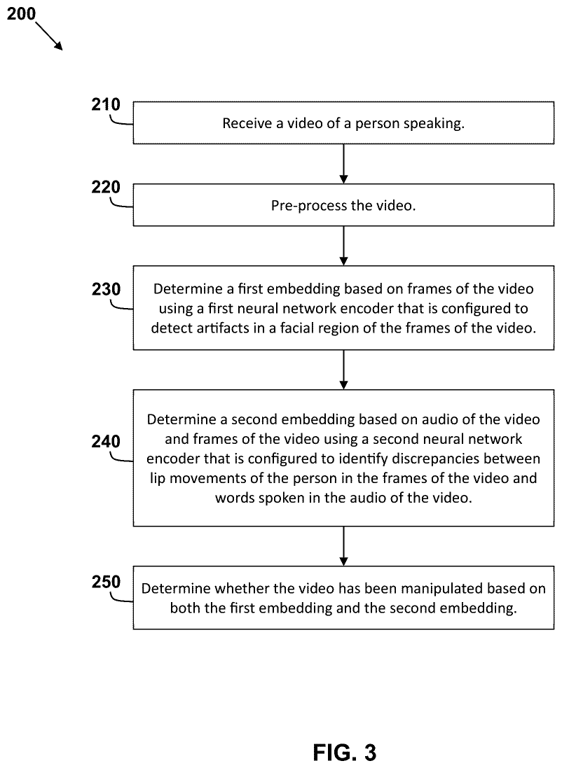

FIG. 3 shows a flow diagram for a method 200 for detecting whether a video is a deepfake video or has otherwise been manipulated. The method 200 advantageously leverages both audio and video information to accurately detect whether the video has been manipulated, e.g., detect whether the video is a so-called ‘deepfake.’ In a video-only pipeline, the method 200 adopts a vision encoder 20 having a feature extractor and a Transformer encoder that leverages self-attention mechanisms to detect artifacts in a facial region of the video. In contrast, in a separate audio-video pipeline, the method 200 adopts an audio +lip encoder 30 having a Transformer encoder that leverages cross-attention mechanisms to identify discrepancies between lip movements of the person and words spoken by the person in the video. These two modalities are used jointly to make an inference as to whether the video has been manipulated.

The method 200 begins with receiving a video of a person speaking (block 210). Particularly, the processor 110 receives a video of a person speaking, which may or may not have been digitally manipulated. The video comprises a plurality of frames (i.e., a time series of images), each including a face of the person as they speak. Additionally, the video comprises audio of the person as they speak. In some embodiments, the processor 110 operates the network communications module 150 to receive the video from another device, such as a remote server or remote client device. In further embodiments, the processor 110 retrieves the video from the memory 120 or from the database 102.

The method 200 continues with pre-processing the video (block 220). Particularly, prior to applying the deepfake detection model 10 to detect whether the video has been manipulated, the processor 110 first pre-processes the video to generate the visual data inputs that will be provided directly to the vision encoder 20 of the deepfake detection model 10 and to generate the audio-visual data inputs that will be provided directly to the audio+lip encoder 30 of the deepfake detection model 10.

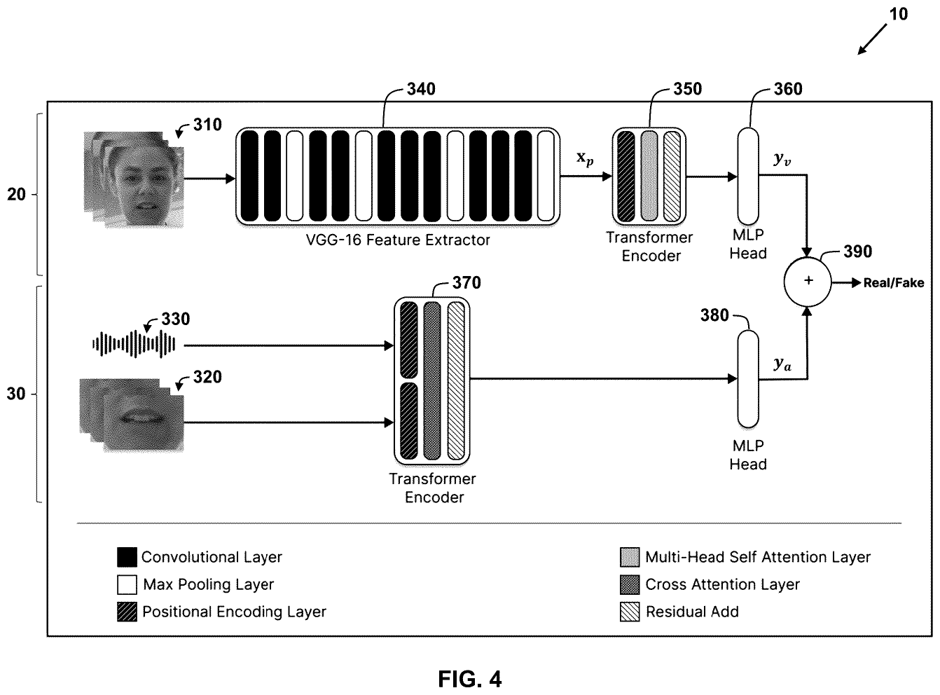

It should be appreciated that the deepfake detection model 10 primarily focuses on the facial region, as this is where most deepfake manipulations occur. To this end, in some embodiments, the processor 110 generates a first plurality of cropped frames, referred to herein as face images 310 (shown in FIG. 4). Each face image 310 is cropped by a bounding box around a face of the person in a respective frame of the video. Additionally, in some embodiments, the processor 110 crops or truncates the raw video to have a predetermined length (e.g., 10 seconds), or otherwise divides the video into segments having the predetermined length, which may be processed separately. The first plurality of cropped frames, i.e., the face images 310, will be provided as input to the vision encoder 20.

To generate the face images 310, the processor 110 first identifies, in each respective frame of the video, a respective bounding box that isolates a facial region of the respective frame (i.e., the face of the person). The processor 110 may, for example, determine these bounding boxes using a face detection model, such as the Multi-task Cascaded Convolutional Network (MTCNN) configured for face detection. Next, the processor 110 crops each respective frame of the video to generate the face images 310.

In at least one embodiment, only a subset of the face images 310 are provided to the vision encoder 20. To this end, the processor 110 identifies a subset of frames of the video and generates a subset of face images 310 that will be provided as input to the vision encoder 20 by cropping the identified subset of frames of the video. In one embodiment, the processor 110 identifies the subset as those corresponding to frames separated by a predetermined time interval (e.g., one third of a second). For example, if the video is 10 seconds in duration and has a frame rate of 30 frames per second, then there are 300 frames in the video. However, computing attention across all 300 frames for each video is computationally expensive. Instead, the processor 110 identifies a subset of only 30 frames that are equally spaced (i.e., every tenth frame is selected). In one embodiment, the processor 110 also resizes the face images 310 to a first predetermined resolution. In one example, the processor 110 resizes the subset of face images 310 to a final size of 256×256×3, where 3 is the number of channels (R, G, B).

Additionally, in some embodiments, the processor 110 generates a second plurality of cropped frames, referred to herein as lip images 320 (shown in FIG. 4). Each lip image is cropped by a bounding box around the lips of the person in a respective frame of the video. The second plurality of cropped frames, i.e., the lip images 320, will be provided as input to the audio+lip encoder 30 of the audio-video pipeline.

To generate the lip images 320, the processor 110 first identifies, in each respective frame of the video, a respective bounding box that isolates a lips region of the respective frame (i.e., the lips of the person). Next, the processor 110 crops each respective frame of the video to generate the lip images 320. Unlike the video-only pipeline, to perform lip-syncing, all frames are used for correlation with the audio (e.g., all 300 frames in the example above). In one embodiment, the processor 110 also resizes the lip images 320 to a second predetermined resolution and converts the lip images 320 to greyscale or black-and-white images, as color is irrelevant for lip-syncing purposes. In one example, the processor 110 resizes the lip images 320 to a final size of 35×140×1.

Finally, in some embodiments, the processor 110 converts the raw audio of the video, which is often stereo audio, into mono audio 330 (shown in FIG. 4), to reduce the input size by half without affecting lip-sync functionality. Additionally, in some cases, the processor 110 crops or truncates the mono audio 330 to have a predetermined length (e.g., 10 seconds) corresponding to a length of the video. In one example, the audio may be recorded at a standard rate of 44.1 KHz and the processor 110 crops the audio to the first 441,000 values, such that the audio is 10 seconds long. The mono audio 330 will be provided as input to the audio+lip encoder 30 of the audio-video pipeline.

After pre-processing the video, the processor 110 passes the face images 310, the lip images 320, and the mono audio 330 to the deepfake detection model 10. FIG. 4 shows a detailed network architecture of the deepfake detection model 10. As can be seen, in the deepfake detection model 10, only the face images 310 are provided to the vision encoder 20. In this way, the vision encoder 20 is considered to be a video-only pipeline. In contrast, both the lip images 320 and the mono audio 330 are provided to the audio +lip encoder 30. In this way, the audio+lip encoder 30 is considered to be an audio-video pipeline.

The method 200 continues with determining a first embedding based on frames of the video using a first neural network encoder that is configured to detect artifacts in a facial region of the frames of the video (block 230). Particularly, after pre-processing the video, for example to generate the face images 310, the processor 110 determines a video artifact output embedding, denoted yᵥ, using the vision encoder 20 and based on the plurality of frames of the video. In at least some embodiments, the processor 110 determines the video artifact output embedding yᵥ, in particular, based on the face images 310. The vision encoder 20 is a neural network encoder incorporating a self-attention mechanism and being configured to detect artifacts in a facial region of the frames of the video.

With reference again to FIG. 4, the vision encoder 20 includes a feature extractor 340, a Transformer encoder 350, and an MLP head 360, which operate to detect artifacts in a facial region of the frames of the video. In summary, the feature extractor 340 extracts image features from the face images 310 to generate a plurality of feature extracted video patches xₚ. The feature extracted video patches xₚ, which may also be referred to herein as tokens, are provided to the Transformer encoder 350 and MLP head 360 to generate the video artifact output embedding yᵥ.

To generate the feature extracted video patches xₚ, the processor 110 applies the feature extractor 340 to each of the face images 310. The feature extractor 340 is configured to extract image features from each respective face image 310, which are subsequently used as input to the Transformer encoder 350. In at least one embodiment, the feature extractor 340 is a convolutional-neural network, such as a Visual Geometry Group (VGG)-16 feature extractor, having a sequence of convolutional layers and max pooling layers.

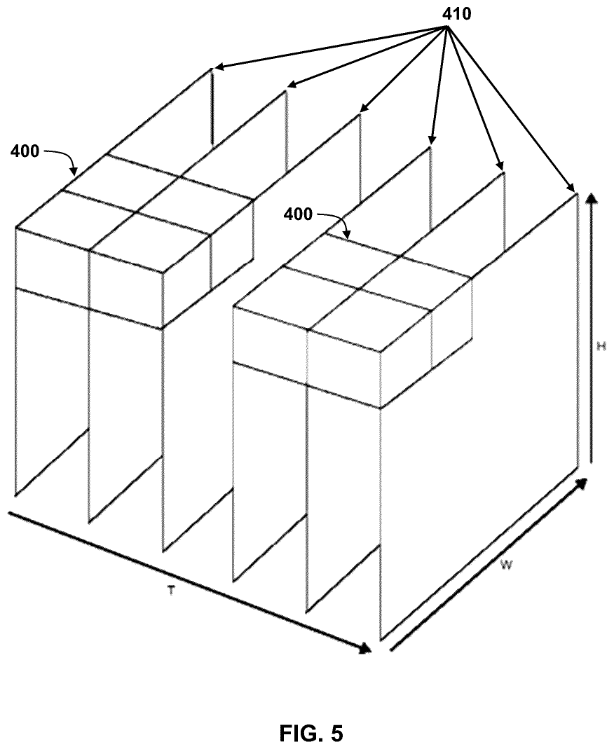

In at least one embodiment, the processor 110 applies a cuboid embedding and flattening process to reshape the raw image features extracted from the face images 310 into the feature extracted video patches xₚ (i.e., tokens) having a particular form. FIG. 5 shows a cuboid embedding for spatio-temporal 3-D attention. Particularly, in one embodiment, the processor 110 uses tubelet embedding to capture the spatiotemporal dimension of the input video frames. Each tubelet 400 is a 3-D volume that captures the height (h), width (w), and depth (t) of the frames 410. The total number of tokens extracted in each dimension can be given as:

$$Number of tokens in time ( {n}_{t} ) = ⌊ \frac{T}{t} ⌋$$

$$Number of tokens in frame height ( {n}_{h} ) = ⌊ \frac{H}{h} ⌋$$

$$Number of tokens in frame width ( {n}_{w} ) = ⌊ \frac{W}{w} ⌋$$

where, H,W,T correspond to the frame height (H), frame width (W) and depth or number of frames in temporal dimension (T). The tubelet embedding method captures both spatial and temporal relationships between frames simultaneously, unlike the uniform frame sampling approach, where each 2D frame is tokenized independently, and temporal embedding information must be provided separately to the Transformer encoder.

Thus, in some embodiments, to generate the feature extracted video patches xₚ, the processor 110 first determines a plurality of raw feature extracted video patches x using the feature extractor 340. The plurality of raw feature extracted video patches x consists of Nₚ patches for each of the N_{f} frames of the face images 310, resulting in Nₚ. N_{f} total raw patches, where Nₚ is a number of spatial divisions in each frame and N_{f} is a number of frames (e.g. 30). Each of the raw patches is extracted from a respective spatial portion of a respective frame of the face images 310. Each of the raw patches is a two-dimensional feature matrix of size P×P, where P is the size of each spatial division in each frame of the face images 310. Thus, the plurality of raw feature extracted video patches x can be denoted as x∈ [symbol] ^{N}^{_{f}}^{×N}^{ₚ}^{×P}^{²}.

Next, the processor 110 determines a plurality of tubelets based on the plurality of raw feature extracted video patches x. Each of the plurality of tubelets is formed from features extracted from corresponding spatial portions over F temporally sequential frames from the face images 310. In other words, to form each tubelet, the processor 110 combines the two-dimensional raw patches from a same spatial region over F sequential frames of the face images 310, resulting in a tensor having dimensions P×P×F, where F is the size of each temporal division. Thus, the plurality of tubelets includes a total of tubelets. Finally, the processor 110 flattens and/or linearizes the plurality of

$$\frac{( {N}_{p} \cdot {N}_{f} )}{F}$$

tubelets to generate the feature extracted video patches xₚ. In particular, the processor 110 converts the three-dimensional tubelets into one-dimensional patches or tokens having a length P²·F. Thus, the flattened feature extracted video patches xₚ can be denoted as:

$${x}_{p} ∈ {ℝ}^{\frac{( {N}_{p} \cdot {N}_{f} )}{F} \times ( {P}^{2} \cdot F )} . \qquad ( 1 )$$

After determining the feature extracted video patches xₚ, the processor 110 applies the Transformer encoder 350 and MLP head 360 to generate the video artifact output embedding yᵥ based on the feature extracted video patches xₚ. The Transformer encoder 350 incorporates a multi-headed self-attention mechanism and is configured to detect artifacts in a facial region of the frames of the video that are indicative of the video having been manipulated. The Transformer encoder 350 includes at least one positional encoding layer, at least one multi-head self-attention layer, and at least one residual addition/connection layers.

The processor 110 first passes the feature extracted video patches xₚ through a linear layer E of dimension (P²·F)×(3·p²·F) to determine a plurality of patch embeddings xₚE. The processor 110 prepends a classification token (z₀⁰=x_{CLS}) to the patch embeddings xₚE. The classification token is a learnable embedding to the sequence of patch embeddings, whose state at the output of the Transformer encoder (z₁⁰) serves as the video representation yᵥ. Finally, the processor 110 adds position embeddings Eₚₒₛ to determine a plurality of position-encoded embeddings zo. The position embeddings Eₚₒₛ are unique to each patch and indicate positional information of the respective patch (i.e., spatial and temporal information indicating from where in the video the features were extracted). In one embodiment, position embeddings Eₚₒₛ are learnable one-dimensional position embeddings. This process can be summarized by:

$${z}_{0} = [ {x}_{C L S} ; {x}_{p}^{i} E ] + {E}_{p o s} , \qquad ( 2 )$$

where xₚⁱ refers to the i^{th} feature extracted video patch, and z₀ is an initial patch embedding of the i^{th} feature extracted video patch.

After the linear projection and positional encoding, the processor 110 passes the initial patch embeddings z₀ through at least one multi-headed self-attention (MSA) layer and at least one multi-layer perceptron (MLP) layer, e.g., the MLP head 360. In some embodiments, the processor 110 applies layer normalization (LN) before the MSA layer and before the MLP layer. In some embodiments, the processor 110 applies residual connections after the MSA layer and after the MLP layer. Finally, after the MLP layer, i.e., the MLP head 360, the processor 110 applies layer normalization (LN) to determine the video artifact output embedding yᵥ. The full process is summarized as follows:

$${z}_{1}^{′} = M S A ( L N ( {z}_{0} ) ) + {z}_{0} \qquad ( 3 )$$

$${z}_{1} = M L P ( L N ( {z}_{1}^{′} ) ) + {z}_{1} \qquad ( 4 )$$

$${y}_{v} = L N ( {z}_{1} ) , \qquad ( 5 )$$

where z′₁ is the output of the MSA layer after residual addition and Z₁ is the output of the MLP layer after residual addition.

As noted above, in the vision encoder 20 of the video-only pipeline, the processor 110 uses multi-headed self-attention (MSA) to compute different attention filters. This is achieved by using the Transformer encoder 350 with multiple sets of Query (Q), Key (K), and Value (V) inputs to obtain n attention layers. In each case, the processor 110 determines the Query (Q), Key (K), and Value (V) based on the feature extracted video patches xₚ inputs and using learnable weight matrices. Additionally, it should be appreciated that self-attention means that the initial Query, Key, and Value are all equal (i.e., Q=K=V). In one example, in the self-attention mechanism used in the vision encoder 20, Q=K=V ∈ [symbol] ^{3073×1280}, where d_{q}=dₖ=dᵥ=1280 is the size of each feature extracted video patch xₚ (i.e., P²·F) and d=3073 is the total number of feature extracted video patches xₚ

$$( i . e . , \frac{( {N}_{p} \cdot {N}_{f} )}{F} )$$

In each of the n attention layers of the Transformer encoder 350, the processor 110 calculates attention by first computing a SoftMax of the scaled cosine similarity between Q and K and then multiplying it with V to compute the attention filter. Thus, the attention filter is summarized as follows:

$$Attention ( Q , K , V ) = softmax ( \frac{Q {K}^{T}}{\sqrt{{d}_{k}}} ) V . \qquad ( 6 )$$

The method 200 continues with determining a second embedding based on audio of the video and frames of the video using a second neural network encoder that is configured to identify discrepancies between lip movements of the person in the frames of the video and words spoken in the audio of the video (block 240). Particularly, after pre-processing the video, for example to generate the lip images 320 and the mono audio 330, the processor 110 determines a lip-sync output embedding, denoted yₐ, using the audio+lip encoder 30 and based on the audio of the video and the plurality of frames of the video. In at least some embodiments, the processor 110 determines the lip-sync output embedding yₐ, in particular, based on the lip images 320 and the mono audio 330. The audio+lip encoder 30 is a neural network encoder incorporating a cross-attention mechanism and being configured to identify discrepancies between (i) lip movements of the person in the plurality of frames of the video and (ii) words spoken in the audio of the video.

With reference again to FIG. 4, the audio+lip encoder 30 includes a Transformer encoder 370 and an MLP head 380, which operate to identify discrepancies between (i) lip movements of the person in the plurality of frames of the video and (ii) words spoken in the audio of the video. Unlike the face images 310 used in the vision encoder 20, the lip images 320 and the mono audio 330 are passed to the Transformer encoder 370 in a raw form, as they are much smaller than the face images 310. In some embodiments, the mono audio 330 is segmented into a plurality of mono audio segments corresponding to the lip images 320. For example, if there are 300 lip images, then the mono audio 330 is segmented into 300 mono audio segments each having 1470 values ( 1/30 of a second long at 44.1 KHz). Additionally, in at least one embodiment, the processor 110 flattens and/or linearizes the lip images 320 and the segments of the mono audio 330 to provide one-dimensional tokens for input into the Transformer encoder 370.

In an essentially similar manner that was discussed above with respect to the Transformer encoder 350 and the MLP head 360, the processor 110 applies the Transformer encoder 370 and MLP head 380 to generate the lip-sync output embedding yₐ based on the lip images 320 and the mono audio 330. The Transformer encoder 370 incorporates cross-attention and is configured to identify discrepancies between (i) lip movements of the person in the plurality of frames of the video and (ii) words spoken in the audio of the video, which are indicative of the video having been manipulated. The Transformer encoder 370 includes at least one positional encoding layer, at least one cross-attention layer, and at least one residual addition/connection layers. In some embodiments, layer normalization (LN) is applied before the cross-attention layer, and residual connections are applied after the cross-attention layer.

As similarly discussed with respect to the Transformer encoder 350, in the Transformer encoder 370, the processor 110 first passes the lip images 320 and the mono audio 330 through a linear layer to determine a plurality of audio-lip embeddings. The processor 110 prepends a classification token to the audio-lip embeddings. Next, the processor 110 adds position embeddings to determine a plurality of position-encoded audio-lip embeddings. After the linear projection and positional encoding, the processor 110 passes the audio-lip embeddings through at least one cross-attention layer and at least one MLP layer, e.g., the MLP head 380. In some embodiments, the processor 110 applies layer normalization (LN) before the cross-attention layer and before the MLP layer. In some embodiments, the processor 110 applies residual connections after the cross-attention layer and after the MLP layer. Finally, after the MLP layer, i.e., the MLP head 380, the processor 110 applies layer normalization (LN) to determine the lip-sync output embedding yₐ.

As noted above, in the audio+lip encoder 30, the processor 110 uses cross-attention to compute different attention filters. To enable cross-attention between the video and audio modalities for lip-synchronization and lip-audio consistency, the different dimensions of Q, K, and V must be considered. Specifically, the processor 110 determines the Query (Q) matrix based on the lip images 320. Accordingly, the Query (Q) matrix has dimensions Q ∈ [symbol] ^{300×4900}, where d_{q}=4900 is the size of each flattened lip image 320 and d=300 is the total number of lip images 320. In contrast, the processor 110 determines the Key (K) and Value (V) matrices based on the segmented mono audio 330. Accordingly, the Key (K) and Value (V) matrices K=V∈ [symbol] ^{300×1470}, where dₖ=dᵥ=1470 is the size of each flattened segment of the mono audio 330 and d=300 is the total number of segments of the mono audio 330.

Since Q and K need to have the same dimensions for computing the cosine similarity, as shown in equation (6), the processor 110 passes Q through a linear layer L₁∈ [symbol] ^{4900×4900}, which reshapes the matrix Q into Q′∈ [symbol] ^{300×4900}. Similarly, the processor 110 passes K through a linear layer L₂∈ [symbol] ^{1470×4900} which reshapes the matrix K into K′∈ [symbol] ^{300×4900}. This reshaping process ensures the compatibility of dimensions and can be summarized as follows:

$$Q \cdot {L}_{1} = {Q}^{′} , {Q}^{′} ∈ {ℝ}^{300 \times 4900} , K \cdot {L}_{2} = {K}^{′} , {K}^{′} ∈ {ℝ}^{300 \times 4900} . \qquad ( 7 )$$

After this reshaping, the processor 110 computes the cosine similarity between Q′ and K′, passes it through a softmax layer and then finally multiplies it with V. In other words, the processor 110 computes the attention filter in the same way as in equation (6), except that Q=Q′ and K=K′.

Finally, the method 200 continues with determining whether the video has been manipulated based on both the first embedding and the second embedding (block 250). Particularly, the processor 110 determines whether the video has been manipulated based on both the video artifact output embedding yy (received from the MLP head 360) and the lip-sync output embedding yₐ (received from the MLP head 380). It should be appreciated that the video artifact output embedding yᵥ and the lip-sync output embedding yₐ can be considered classification labels determined by the video-only pipeline and the audio-video pipeline, respectively. The processor 110 concatenates the video artifact output embedding yy and the lip-sync output embedding yₐ to obtain a joint embedding y∈ [symbol] ^{2d}, where d is the dimension of the transformer embedding outputs (e.g., d=2). Finally, the processor 110 passes the joint embedding y through a linear layer of size d×2 to determine the final classification probability indicating whether the video has been manipulated (i.e., whether the video is a deep fake).

After determining the final classification probability indicating whether the video has been manipulated, the processor 110 stores the final classification probability or corresponding classification label in the memory 120 or in the database 102 in association with the video. In some embodiments, the processor 110 operates the display screen 130 to display of the final classification probability or corresponding classification label. In some embodiments, the processor 110 operates the network communications module 150 to transmit the final classification probability or corresponding classification label to another device, such as a remote server or remote client device.

### Experimental Results

The deepfake detection model 10 was tested on the Deepfake Detection Challenge (DFDC) dataset, the DeepfakeTIMIT (DF-TIMIT) dataset, and the FakeAVCeleb dataset, which were the only known dataset containing deepfake in both audio and video modality. During training of the deepfake detection model 10, the batch size was 8 videos with a total of 1310 batches per epoch. The loss function used is was Cross Entropy loss with a learning rate of 10⁻⁶. When computing the accuracy for each epoch, accuracy was computed for each batch and average the accuracy across all batches was computed in every epoch to report accuracy per epoch. Table 1 summarizes a performance evaluation of the deepfake detection model 10 on these three different datasets:

TABLE 1

| Dataset | AUC | F1 |
|---|---|---|
| DFDC | 0.979 | 92.7% |
| FakeAVCeleb | 0.748 | 84.8 |
| DF-TIMIT | 1.000 | 100.0 |

Additionally, to demonstrate the improved accuracy of the multi-modal approach adopted by the deepfake detection model 10, comprehensive ablation studies were conducted. The results are compared with prior unimodal techniques and it is established that the multi-modal approach adopted by the deepfake detection model 10 outperforms them. Particularly, additional experiments were conducted using the DFDC dataset. The DFDC dataset is a large-scale public dataset designed to spur research in the detection of deep fake videos. The dataset contains 23,654 real videos and 104,500 fake videos that are generated using a variety of deep learning techniques to manipulate video content, such as face-swapping and lip-syncing, to create realistic fake videos. The DFDC dataset is composed of two parts: the DFDC Training Dataset, which contains 60,000 training videos, and the DFDC Validation Dataset, which contains 40,000 videos for validation and testing.

The deepfake detection model 10 was evaluated against ten different prior methods on DFDC using AUC scores. To ensure a fair comparison, 18,000 samples were randomly selected from DFDC, as the subsets of DFDC on which the baseline methods were trained and tested were unknown. However, the prior methods report per-frame AUC scores only.

The prior methods that were used for comparison are as follows: (1) Two-Stream, which adopts a two-stream CNN with standard CNN network architectures; (2) MesoNet, which leverages CNNs that target the mesoscopic image features; (3) HeadPose, which leverages headpose disorientation across different frames; (4) FWA, which exposes the facial distortion caused by image resize and interpolation by CNN; (5) VA, which focuses on detecting artifacts introduced at different facial components such as the eyes, teeth, and contours; (6) Xception, which employs the XceptionNet model trained on Face Forensics++; (7) Multi-task, which first identifies manipulated images and performs multiple segmentation to solve the problem of multi-task segmentation learning; (8) Capsule, which adopts groups of neurons called capsules to capture hierarchical relationships between different features in an image; (9) DSP-FWA, which is an upgraded iteration of FWA that incorporates a fixed-length image representation module to effectively manage resolution variances in the initial target faces; and (10) Emotions Don't Lie, which uses emotional and affect cues and consistency to differentiate between real and deep-faked videos.

Table 2 compares AUC scores on the DFDC dataset with the prior methods. As can be seen the deepfake detection model 10 strongly outperforms all of the prior methods tested, including models with significantly more parameters.

TABLE 2

| Model | AUC |
|---|---|
| (8) Capsule | 0.533 |
| (7) Multi-task | 0.536 |
| (3) HeadPose | 0.559 |
| (1) Two-stream | 0.614 |
| (5) VA-MLP | 0.619 |
| (5) VA-MLP | 0.662 |
| (2) MesoInception4 | 0.732 |
| (2) Meso4 | 0.753 |
| (6) Xception-raw | 0.499 |
| (6) Xception-c40 | 0.697 |
| (6) Xception-c23 | 0.722 |
| (4) FWA | 0.727 |
| (9) DSP-FWA | 0.755 |
| (10) Emotions Don't Lie | 0.844 |
| Deepfake Detection Model 10 | 0.979 |
| (Our Approach) | |

Two ablation studies were also conducted to evaluate the contribution of different components of network architecture of the deepfake detection model 10. In a first ablation study, the audio pipeline was removed, rendering the model unimodal. The ablated unimodal pipeline utilized in the study involved only the video modality without audio. The investigation revealed that the ablated unimodal method is significantly better compared to other state-of-the-art unimodal approaches, as evidenced by the results presented in Table 2. Nevertheless, it is maintained that, for datasets with deepfakes in both audio and video modalities, the full network architecture of the deepfake detection model 10 is better suited to detect lip-synchronization discrepancies in many deepfake-generated videos.

In a second ablation study, the Transformer Encoder 350 was removed, leaving only the VGG-16 feature extractor 340 in the video-only pipeline. Likewise, the Transformer Encoder 350 was also removed from the ablated unimodal pipeline and the classification was performed based only on the features extracted by the VGG-16 feature extractor 340. The results show that the accuracy of such a fine-tuned VGG-16 feature extractor 340 gives an accuracy of 87.90% and an F-1 score of 87.77% as shown in Table 3. While the accuracy is high for an independent VGG-16 network, the addition of transformers after feature extraction still provides valuable gains.

Table 3 shows a comparison of AUC and F1 scores evaluation metric on DFDC dataset with the prior unimodal video-only methods.

TABLE 3

| Model | AUC | F1 | # param |
|---|---|---|---|
| ViT with distillation | 0.978 | 91.9% | 373M |
| Selim EfficientNet B7 | 0.972 | 90.6% | 462M |
| Convolutional ViT | 0.843 | 77.0% | 89M |
| Efficient ViT | 0.919 | 83.8% | 109M |
| Convolutional Cross ViT | 0.925 | 84.5% | 142M |
| (Wodajo CNN) | | | |
| Convolutional Cross ViT | 0.947 | 85.6% | 101M |
| (Efficient Net B0—Avg) | | | |
| Convolutional Cross ViT | 0.951 | 88.0% | 101M |
| (Efficient Net B0—Voting) | | | |
| Ablated Unimodal Pipeline | 0.980 | 93.2% | 27M |
| (Our Approach) | | | |

Table 4 shows an overall comparison of AUC and F1 scores evaluation metric on DFDC dataset after removing parts of multimodal network.

TABLE 4

| Model | AUC | F1 | # param |
|---|---|---|---|
| Multimodal Approach | 0.979 | 92.7% | 90M |
| Unimodal Approach | 0.980 | 93.2% | 27M |
| (Removing Lip-Audio Pipeline) | | | |
| Fine-Tuned VGG-16 Features Only | 0.944 | 87.7% | 7M |

As can be appreciated from the experimental results discussed above, the deepfake detection model 10 provides clear and quantifiable improvements to deepfake detection technology. Moreover, the deepfake detection model 10 provides such improvements using a comparatively lightweight and efficient model having fewer parameters than many prior methods. In this way, the deepfake detection model 10 can be deployed more effectively in a wider variety of platforms and applications.

Embodiments within the scope of the disclosure may also include non-transitory computer-readable storage media or machine-readable medium for carrying or having computer-executable instructions (also referred to as program instructions) or data structures stored thereon. Such non-transitory computer-readable storage media or machine-readable medium may be any available media that can be accessed by a general purpose or special purpose computer. By way of example, and not limitation, such non-transitory computer-readable storage media or machine-readable medium can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media or machine-readable medium.

Computer-executable instructions include, for example, instructions and data which cause a general-purpose computer, special purpose computer, or special purpose processing device to perform a certain function or group of functions. Computer- executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A method for detecting whether a video has been manipulated, the method comprising:
receiving, with a processor, a video including a plurality of frames and audio of a person speaking;
determining, with the processor, a first embedding based on the plurality of frames of the video using a first neural network, the first neural network incorporating a self-attention mechanism and being configured to detect artifacts in a facial region of the plurality of frames of the video;
determining, with the processor, a second embedding based on the audio of the video and the plurality of frames of the video using a second neural network, the second neural network incorporating a cross-attention mechanism and being configured to identify discrepancies between (i) lip movements of the person in the plurality of frames of the video and (ii) words spoken in the audio of the video; and
determining, with the processor, whether the video has been manipulated based on both the first embedding and the second embedding.

2. The method according to claim 1, the determining the first embedding further comprising:
generating a first plurality of cropped frames, each cropped frame of the first plurality of cropped frames being cropped by a bounding box around a face of the person in a respective frame of the plurality of frames.

3. The method according to claim 2, the generating the first plurality of cropped frames further comprising:
identifying a subset of the plurality of frames of the video; and
generating the first plurality of cropped frames by cropping the subset of the plurality of frames of the video.

4. The method according to claim 2, the generating the first plurality of cropped frames further comprising:
resizing each of the first plurality of cropped frames to a first predetermined resolution.

5. The method according to claim 2, the determining the first embedding further comprising:
determining a plurality of patches by extracting features from each of the first plurality of cropped frames using a feature extractor of the first neural network.

6. The method according to claim 5, the determining the plurality of patches further comprising:
determining a plurality of raw patches corresponding to features extracted from portions of each of the first plurality of cropped frames using the feature extractor of the first neural network;
determining a plurality of tubelets, based on the plurality of raw patches, corresponding to features extracted from corresponding portions over a plurality of temporally sequential frames from the first plurality of cropped frames; and
determining the plurality of patches by flattening the plurality of tubelets.

7. The method according to claim 5, the determining the first embedding further comprising:
determining the first embedding based on the plurality of patches using a Transformer encoder of the first neural network having a multi-headed self-attention mechanism.

8. The method according to claim 7, the determining the first embedding further comprising:
determining a plurality of patch embeddings based on the plurality of patches using a linear layer; and
determining a first plurality of position-encoded embeddings by embedding position information into the plurality of patch embeddings,
wherein the first embedding is determined based on the first plurality of position-encoded embeddings.

9. The method according to claim 7, the determining the first embedding further comprising:
determining Query, Key, and Value matrices based on the plurality of patches; and
determining the first embedding using the Transformer encoder of the first neural network and the Query, Key, and Value matrices.

10. The method according to claim 9, the determining the first embedding further comprising:
determining the first embedding based on a final output of the Transformer encoder of the first neural network using a multi-layer perceptron.

11. The method according to claim 1, the determining the second embedding further comprising:
generating a second plurality of cropped frames, each cropped frame of the second plurality of cropped frames being cropped by a bounding box around lips of the person in a respective frame of the plurality of frames.

12. The method according to claim 11, the generating the second plurality of cropped frames further comprising:
resizing each of the second plurality of cropped frames to a second predetermined resolution.

13. The method according to claim 11, the generating the second plurality of cropped frames further comprising:
converting the second plurality of cropped frames to greyscale.

14. The method according to claim 11 further comprising:
converting the audio of the video into mono audio.

15. The method according to claim 5, the determining the second embedding further comprising:
determining the second embedding based on the second plurality of cropped frames and the audio of the video using a Transformer encoder of the second neural network having a cross-attention mechanism.

16. The method according to claim 15, the determining the first embedding further comprising:
determining a second plurality of position-encoded embeddings by embedding position information into the second plurality of cropped frames and the audio of the video,
wherein the second embedding is determined based on the second plurality of position-encoded embeddings.

17. The method according to claim 15, the determining the first embedding further comprising:
determining a Query matrix based on the second plurality of cropped frames;
determining Key and Value matrices based on the audio of the video; and
determining the second embedding using the Transformer encoder of the second neural network and the Query, Key, and Value matrices.

18. The method according to claim 17, the determining the second embedding further comprising:
determining the second embedding based on a final output of the Transformer encoder of the second neural network using a multi-layer perceptron.

19. The method according to claim 1, the determining whether the video has been manipulated further comprising:
determining a joint embedding by concatenating the first embedding and the second embedding; and
determining whether the video has been manipulated based on the joint embedding using a linear neural network layer.

20. A non-transitory computer-readable medium that stores program instructions for detecting whether a video has been manipulated, the program instructions being configured to, when executed by a processor, cause the processor to:
receive a video including a plurality of frames and audio of a person speaking;
determine a first embedding based on the plurality of frames of the video using a first neural network, the first neural network incorporating a self-attention mechanism and being configured to detect artifacts in a facial region of the plurality of frames of the video;
determine a second embedding based on the audio of the video and the plurality of frames of the video using a second neural network, the second neural network incorporating a cross-attention mechanism and being configured to identify discrepancies between (i) lip movements of the person in the plurality of frames of the video and (ii) words spoken in the audio of the video; and
determine whether the video has been manipulated based on both the first embedding and the second embedding.
